(19) United States
(12) Patent Application Publication
(10) Pub. No.: US 2013/0171325 A1
(43) Pub. Date: Jul. 4, 2013

(54) VACUUM DRIED FRUIT PRODUCT

(71) Applicant: Chiquita Brands International Inc., Charlotte, NC (US)

(72) Inventors: Javier Palacio, Duran (EC); Julio Vasquez, Miami, FL (US); Ilya Ilyin, Wayland, MA (US)

(73) Assignee: Chiquita Brands International Inc., Charlotte, NC (US)

(21) Appl. No.: 13/715,035

(22) Filed: Dec. 14, 2012

Related U.S. Application Data
(60) Provisional application No. 61/580,806, filed on Dec. 28, 2011.

(51) Int. Cl. A23L 1/212

(52) U.S. Cl. CPC A23L 1/2123
USPC 426/640

(57) ABSTRACT

The present invention defines an apparatus and a process for vacuum drying fruit or vegetables, particularly tropical fruit, such as bananas, mangos and pineapples, so as to provide an exceptionally sweet and flavorful fruit chip snack product which is substantially free of any additives such as frying oil, preservatives, added sugar and artificial sweeteners. The process is a vacuum drying process and utilizes a drying apparatus in the form of an autoclave which contains within it a stacked platen heat exchanger wherein trays of the fruit to be dried are placed between heated platens in the heat exchanger. The platens are heated using hot water or a hot water/steam mixture and the drying is done in the autoclave under pressure.

### TECHNICAL FIELD

This application is related to and claims priority from U.S. Provisional Patent Application Ser. No. 61,580,806, filed Dec. 28, 2011, incorporated herein by reference.

The present invention relates to snack products made from fresh fruit and vegetables, particularly tropical fruit, such as bananas, pineapples and mangos.

### BACKGROUND

Snacks and snack foods have become a part (although not always a perfect or desirable part) of many people's diet. Snack foods, such as potato chips, corn chips, taco chips, cheese puffs, crackers, cookies, or pretzels, can provide an accompaniment to meals (such as a “side dish” to have with a sandwich for lunch) or a snack to be eaten themselves between meals. Many popular snack foods are fried or contain salt or sugar or other components which are not preferred from a dietary point of view. Part of the recent emphasis, therefore, in the snack food industry, has been towards healthful snacks, such as those derived from fresh fruit, which contain nutrients, minerals, fiber and other desirable dietary components. Thus, raisins, dried cranberries, dried cherries, and fruit leather have become desired and popular snack products.

One segment of the healthy snack food industry consists of chip-type products which are made from fresh fruit. Such products not only have the desirable nutritional characteristics of fruit-based products, but they also exhibit the size and crispness characteristics which are found with chips, something which is favored by many snack food consumers. Examples of such products, which are currently available, include banana, apple, pear, pineapple or mango slices which have been fried or freeze-dried to form a chip-type product. When such products are made by frying, while they do retain the desired crunchiness, the natural flavor of the fruit is sometimes compromised by the frying process and such products contain significant amounts of oil, which nutritionally can be a problem. While freeze-drying retains the natural flavor of the fruit, and minimizes oil content, it frequently does not provide the crunchiness and mouth-feel which is optimal for a chip-type product. Further, many of the current products include added sugars, artificial sweeteners, and preservatives, which are not desirable in natural fruit snack products.

The present invention defines a dried fruit chip-type product and a process for preparing such a dried fruit product, under vacuum, particularly using tropical fruit, such as bananas, mangos and pineapples, so as to provide an exceptionally sweet, crisp and flavorful chip snack product without the use of any additives, including frying oil, preservatives, added sugar or other sweeteners. The process utilizes a vacuum drying apparatus in the form of an autoclave which contains within it a vertical stacked platen heat exchanger wherein trays of the fruit to be dried are placed between heated platens in the heat exchanger. The platens are heated using hot water or a hot water/steam mixture and the drying is done in the autoclave under reduced pressure.

The process of vacuum-drying is known, although not for fruit snacks. For example, Mitchell Driers Ltd. manufactures and sells a vacuum tray drier which comprises a vacuum stacked platen/tray drier configuration, generally used for high-end drying operations, such as for drying pharmaceutical products.

U.S. Pat. No. 3,521,373, Pagnozzi, issued Jul. 21, 1970, describes a process and apparatus for the vacuum drying of wood. The process uses flat heating elements placed between the wood sheets to be dried. The process does not utilize hot water or a hot water/steam mixture to heat the platens and does not teach the drying of foods, so that there is no consideration of taste or texture involved in the disclosed process.

U.S. Pat. No. 4,190,965, Erickson, issued Mar. 4, 1980, describes the use of stackable drying trays and warm air circulation in a process for drying food products.

U.S. Pat. No. 5,235,903, Tippmann, issued Aug. 17, 1993, describes a cooking oven which uses steam at reduced pressure as the heat transfer medium; it does not disclose a stacked platen/tray construction.

U.S. Pat. No. 6,068,874, Grocholski, issued May 30, 2000, describes a process for dehydrating fruits and vegetables in a closed system to maintain their flavors. In the process, hot air is blown across the surface of the fruit or vegetable pieces which are held on trays or shelves. The process does not utilize a stacked platen/tray configuration.

U.S. Pat. No. 6,688,018, Soucy, issued Feb. 10, 2004, describes the use of hot air circulation and reduced air pressure to dry fruit products.

Great Britain Published Patent Specification GB 12,453, Passburg, published Jul. 19, 1972, describes a process for the vacuum drying of fruits and vegetables using alternating application of steam (for heat addition) and water (for heat withdrawal). The application does not teach the use of a stacked platen/tray construction.

### SUMMARY

The present invention relates to a vacuum-dried fruit or vegetable product, for example, made from fruit slices selected from banana, pineapple, mango, papaya, apple and pear, said product slices having a thickness of from about 2 mm to about 9 mm, a moisture content of from about 1% to about 7%, a porosity of no greater than about 0.45, and being substantially free of frying oil, preservatives, added sugar and artificial sweeteners.

Preferred products utilize tropical fruit, such as bananas, pineapples and mangos to make the dried fruit product. The porosity, hardness, maximum load (i.e., crispness), and color of the chip product can also be defined.

The present invention also encompasses a process for drying fruit pieces by placing said fruit pieces in an apparatus which comprises an autoclave containing within it, in a stacked configuration, a plurality of flat platens, spaced apart from each other in the vertical direction, which are internally heated by hot water (or a water/steam mixture) and a plurality of trays to hold said fruit pieces, said trays being insertably placed between and parallel to the heated surface of adjacent pairs of said platens, and drying said fruit pieces under heat and vacuum to a final moisture content of from about 1% to about 7%.

One embodiment of the present invention encompasses a process for drying fruit pieces utilizing an apparatus which comprises an autoclave containing within it, in a stacked configuration, a plurality of substantially flat platens, stacked apart from each other in the vertical direction, which are internally heated by hot water (or a water/steam mixture), and a plurality of trays to hold said fruit pieces, said trays being insertably placed between and parallel to the heated surfaces of adjacent pairs of said platens, said process comprising the steps of:

(a) placing the fruit pieces, having a thickness of from about 3 mm to about 12 mm on the trays;

(b) inserting each tray between an adjacent pair of platens;

(c) providing a vacuum inside the autoclave of from about 23 inches of mercury to about 30 inches of mercury during the drying process;

(d) heating the platens using hot water (or a water/steam mixture) at a temperature of from about 80° C. to about 92° C., and wherein the temperature of the air in the autoclave is heated to between about 45° C. and about 66° C. during the drying process;

(e) continuing the drying process for a period of from about 210 minutes to about 390 minutes, until the moisture content in said fruit pieces is reduced to from about 1% to about 7%; and

(f) removing the dried fruit pieces from the autoclave.

In one embodiment, after the fruit pieces are removed from the autoclave in step (f), the dried fruit pieces are placed in a room (or other controlled environment) having a temperature of from about 8° C. to about 20° C., and a humidity of from 40% to about 60%, for a period of from about 0.5 hour to about 1 hour.

Unless otherwise noted, all percentages and ratios specified herein are “by weight”. Further, all patents and other publications cited in this application are incorporated herein by reference.

### BRIEF DESCRIPTION OF THE DRAWINGS

FIG. 1 shows a cutaway view of an embodiment of the autoclave utilized in the process of the present invention. The autoclave illustrated contains 1 hot water heated platens, in a vertical stack, with 15 gaps between them. The apparatus can hold 30 trays of fruit slices (2 trays per gap, side-by-side). At the left of the platens is the hot water manifold which distributes hot water to the platens.

FIG. 2 shows detail of the autoclave and particularly the gaps between adjacent platens used for inserting the trays holding the fruit pieces.

FIG. 3 shows detail of the hot water inlet feeding for the platens.

FIG. 4 shows a tray, which can be used to hold fruit pieces, inserted as a drawer between adjacent platens.

It is to be emphasized that these figures illustrate but one embodiment of the autoclave used in the present invention. Other structures, for example those using trays of different size or shape, having different numbers of platens, or having a gap of different size between adjacent platens, can be used.

### DETAILED DESCRIPTION

The present invention provides a process for preparing a unique dried fruit or vegetable slice product, as well as the product made by that process.

The vacuum dried fruit product of the present invention is made from slices of fruits or vegetables. Examples of vegetables which can be used include carrots, beets or lettuce. Examples of fruit useful herein include tropical fruit, such as bananas, pineapple, mango, papaya, starfruit or tomato; or red fruit, such as apples, pears, strawberries or other berries (such as blackberries or blueberries or raspberries). In one embodiment, the product is made from tropical fruit selected from bananas, pineapples and mangos; bananas are frequently used. The slices utilized have a thickness of from about 3 mm to about 12 mm (for example, from about 3 mm to about 10 mm) when fresh, and from about 2 mm to about 9 mm after the drying is completed. The dried product has a moisture content of from about 1% to about 7%, such as from about 1% to about 5%. Further, the dried product is substantially free of undesirable additives selected from frying oil, preservatives, added sugar, and artificial sweeteners. The term “added sugar” refers to sugar which is added to the fruit to supplement the fructose naturally contained in the fruit. As used herein, the term “substantially free” is intended to mean that the final product contains no more than about 0.5%, such as no more than about 0.1%, and further such as no more than about 0.05% of the combination of those additives. The preferred product contains zero added sugar. As used herein, the use of the word “fruit” generally is intended to encompass vegetables, as well.

Exemplary products of the present invention have a porosity of no greater than about 0.45. Specifically, chips made from bananas and dried frequently have a porosity of from about 0.35 to about 0.45; chips made from pineapple frequently have a porosity of from about 0.3 to about 0.45, and chips made from mango frequently have a porosity of from about 0.2 to about 0.3.

The structure of a food material may be characterized by its apparent density, true density, porosity, pore size distribution and specific volume. Apparent density (ρ_{b}) deals with powdered and porous materials and it is determined by the mass of the sample and its apparent volume. True density (ρₚ) is the density excluding all pores, and it is determined by the mass of the sample and its true volume. Porosity (ε) characterizes the overall open structure of a dehydrated material. It is the fraction of the empty volume (void fraction) and it is usually estimated from the apparent density and the true density of the material according to the following equation:

ε=1−ρ_{b}/ρₚ

The mass of an irregular solid is determined by weighing. When the solid is placed in a pycnometer filled with a liquid of known density, the volume of the liquid which will overflow is equal to the volume of the solid. The mass of the liquid which will overflow is determined as the difference between the sum of the mass of the pycnometer filled with liquid plus the mass of the solid and the mass of the pycnometer filled with liquid after the solid has been placed inside. The volume occupied by this mass is determined from the known density of the liquid. It is necessary that the solid be insoluble in the liquid used. The density of the solid is determined from these measurements of mass and volume.

In order to determine true density of fruit chips, we milled the fruit chips to powder and pressed the powder in a special press under pressure of 2186 Bars for 30 minutes. Obtained tablets and fruit chips were coated with paraffin to prevent water absorption in the pycnometer.

Weight of pycnometer with water and sample is:

mₚₛᵥ=mₚ+mₛ+ρ_{w}·(V_{w}−Vₛ)

mₚₛᵥ=mₚ+mₛ+ρ_{w}·(V_{w}−Vₛ)

where m_{psw}=weight of the pycnometer with water and sample, mₚ=weight of pycnometer without water and sample, ρ_{w}=water density, V_{w}=pycnometer volume without sample, and Vₛ=sample volume. Therefore, sample volume is:

$${V}_{s} = \frac{{ρ}_{w} \cdot {V}_{w} - {m}_{psv} + {m}_{p} + {m}_{s}}{{ρ}_{w}}$$

$${ρ}_{w} \cdot {V}_{w} = {m}_{pw} - {m}_{p}$$

where m_{pw}=weight of the pycnometer filled by water only, without sample. Therefore, the final formula for sample (coated by paraffin) volume is:

$${V}_{s} = \frac{{m}_{pw} - {m}_{psv} + {m}_{s}}{{ρ}_{w}}$$

Density of a clean sample (a sample without paraffin) will be:

$${ρ}_{cs} = \frac{{m}_{cs}}{{V}_{s} - \frac{{m}_{ps} - {m}_{cs}}{{ρ}_{p}}}$$

where m_{cs}=weight of clean sample, mₚₛ=weight of paraffin-coated sample, and ρₚ=density of paraffin.

Porosity will be:

$$ɛ = 1 - \frac{{ρ}_{chips}}{{ρ}_{tablet}}$$

where ρ_{chips}=chips density, and ρ_{tablet}=tablet density.

Because the mouth-feel and crispness of a chip product are important organoleptic characteristics of that product, the hardness and the maximum load of the dried chip product can also be determined. When measured, the chips are aged for no greater than four days after manufacture. Typically, dried banana chips of the present invention have a hardness (HV0.01) of at least about 7.0 kgf/mm², and, for example, at least about 8.0 kgf/mm². Dried pineapple chips of the present invention have a hardness (HV0.01) of at least about 10.0 kgf/mm², and, for example, at least about 12.0 kgf/mm²; and dried mango chips of the present invention have a hardness (HV0.01) of at least about 5.5 kgf/mm². In some embodiments, dried banana chips of the present invention have a maximum load (Fₘₐₓ) of at least about 35N.

As that term is used herein, the hardness (HV0.01) is measured using the following procedure:

HV0.01 is a Vickers number. Vickers hardness is a measure of the hardness of a material, calculated from the size of an impression produced under load by a pyramid-shaped diamond indenter.

The indenter employed in the Vickers test is a square-based pyramid whose opposite sides meet at the apex at an angle of 136 degrees. The diamond is pressed into the surface of the material at loads ranging up to approximately 120 kilograms-force, and the size of the impression (usually no more than 0.5 mm) is measured with the aid of a calibrated microscope. The Vickers number (HV) is calculated using the following formula:

HV=1.854(F/D2),

with F being the applied load (measured in kilograms-force), and D2 the area of the indentation (measured in square millimetres). The applied load is usually specified when HV is cited. In our case, HV0.01 means that the applied load was 0.01 kg.

Also as used herein, the maximum load (Fₘₐₓ) is measured using the following procedure:

The maximum load Fₘₐₓ is measured using the UTS 10 system (UTStestsysteme, Germany). It is a regular load measuring device, where the load gradually increases and the resistance of the sample to that load is recorded. Each test is performed until the sample is crushed and no resistance is detected. The maximum load is a number characterizing the maximum load necessary to crash the chip. The actual value of maximum load depends on the type of the indenter and how the fruit chip is fixed on the base of the device. One of the indenters used to measure the fruit chips was a cylinder flat bottom of 8 mm in diameter. The fruit chip was placed on the washer with 16 mm internal diameter.

The color of the dried fruit slice product can also be important, with the goal being to prepare a final product having color characteristics which are not too dark, and are relatively close to the color characteristics of the natural undried fruit. Thus, for example, in one embodiment, the dried banana slices of the present invention can have colorimetric values (xyz CIE) wherein x is from about 38 to about 42; y is from about 36 to about 40; and z is from about 19 to about 23.

A spectrometer is used herein for measuring the reflection index of diffusely reflective objects, such as the dried fruit products of the present invention, and for determining their color and metric parameters (in accepted colorimetric systems). The spectrometer comprises the following components: an illuminator on the basis of a photometric integrating sphere (with a diameter of 70 mm), in which a krypton incandescent lamp is used; and a spectral unit that is made as a polychromator and that includes a concave defraction grating (Type I) N=600 line/mm, R=62.5 mm together with CCD straight scale. In the spectrometer the following settings are used:
Spectral operating range=380-760 nm
Spectral resolution limit=5 nm
Photometric error=1%
Requirements to samples: operative zone diameter=no less than 12 mm.

The sample is inserted into the spectrometer and the reflection index is measured.

The dried fruit chip products of the present invention are healthy, are sweet, retain much of the natural fruit flavor, have a crisp desirable mouth-feel and are substantially free of undesirable additives such as frying oil, preservatives, added sugar and artificial sweeteners.

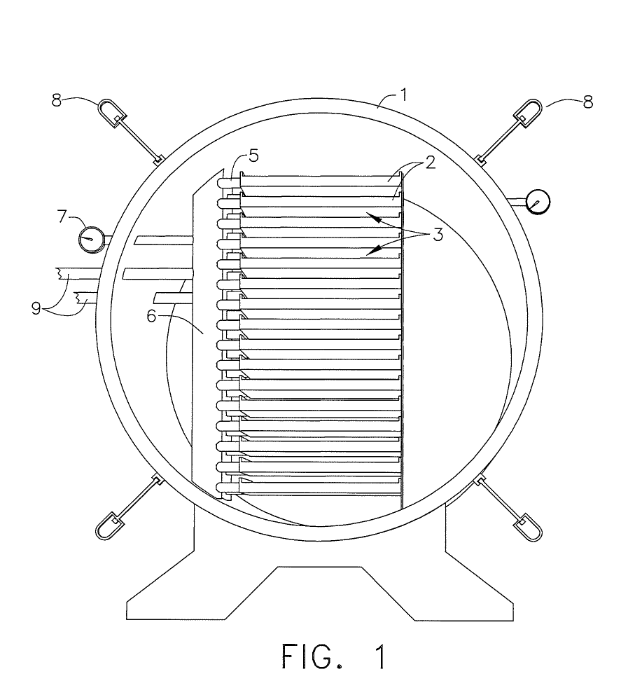

The dried fruit products of the present invention are made using an autoclave which holds the fruit slices under heating and vacuum during the drying process. The vacuum range during the drying process is generally from about 23 inches of mercury to about 30 inches of mercury. Drying under vacuum is important in preventing discoloration of the product and allowing for drying at a low temperature. One embodiment of the autoclave (1) is illustrated in FIGS. 1 through 4 attached hereto and which have been previously described. In brief, the apparatus comprises an autoclave (1) in which the interior air pressure can be controlled (as measured by gauge (7)), which includes a series of substantially flat platens (2) which act as heat exchangers. The platens are stacked vertically with spaces (3) between vertically adjacent platens. The platens are heated and trays (4), which hold the fruit slices to be dried, are inserted in the space (3) between adjacent platens. In this way, the fruit slices are subjected to heat and vacuum during the drying process. The autoclave (1) is sealed by a door (not shown) which is fastened into place by latches (8). The vacuum may be created by, for example, a vacuum pump (not shown).

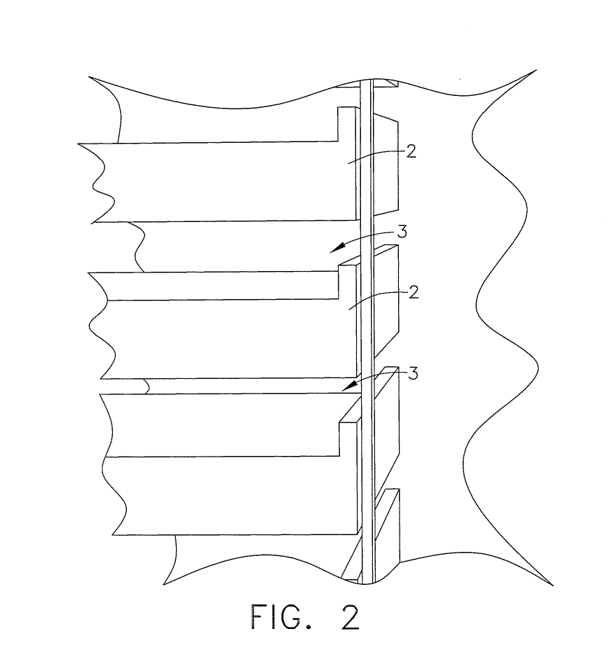

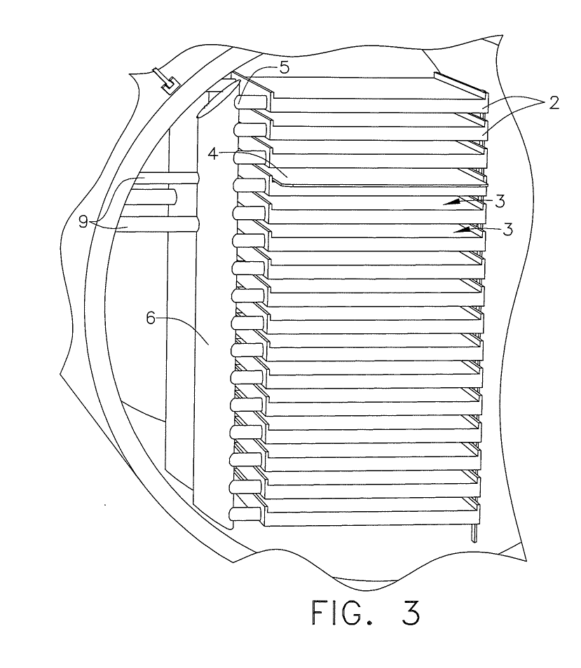

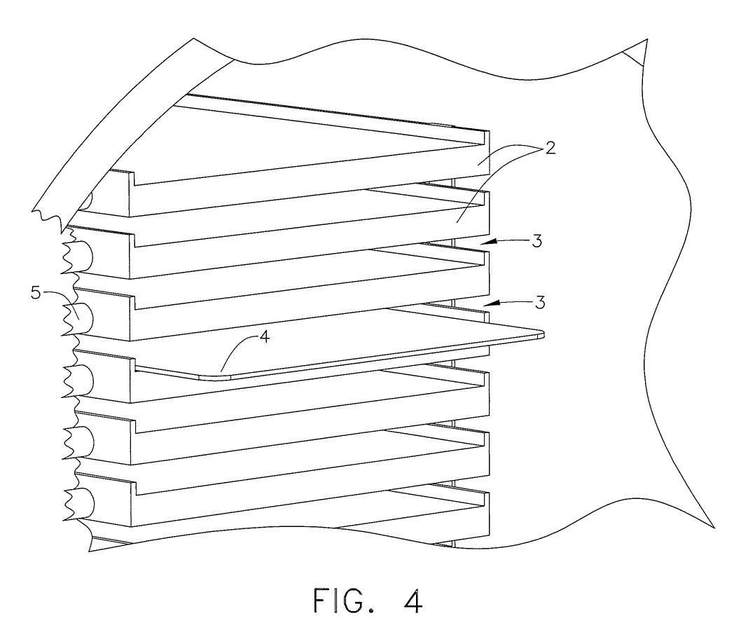

The flat platens (2) which are utilized in the vacuum drying device are generally made from stainless steel (although other metals which are food grade and which have durability and heat transfer properties similar to stainless steel can also be used); they act as heat exchangers and they include pipes or tubes or channels within them which allow for the circulation of water or a water/steam mixture in order to heat (or cool) the platen and thereby heat or cool the atmosphere inside the autoclave. In one embodiment, the platens (2) are made from stainless steel (e.g., Stainless Steel 304) having a thickness of about 1.6 mm. The platens generally have a rectangular or a round shape and each one typically has a surface area of from about 1.25 to about 19 square meters. Each platen is internally heated (or cooled) by including pipes (5) or channels which allow water or a water/steam mixture to flow through them, thereby transferring heat or removing heat from the platen itself. The water is introduced into each platen through a manifold (6), and the water is introduced into the manifold through intake/outflow pipes (9). The thickness of each platen (2) is determined by the piping (5) or channels contained within it. Generally, each platen is from about 1 to about 3 inches in thickness. The platens (2) are placed in the autoclave with their top and bottom faces parallel to each other (and to the floor) in a vertical stack with spaces (3) in between vertically adjacent platens which act to hold trays (4) of the fruit slices to be dried. The platens can be such that only a single tray of fruit pieces can fit between adjacent platens, or the surface area can be significantly larger permitting two or more trays to be placed side-by-side between adjacent platens. The placement of the trays in the autoclave between the platens is illustrated in FIG. 4 of the present application. Further, the manifold (6) which distributes the hot water to the individual platens is illustrated in FIG. 3 and the vertical spaced apart placement of the platens in a vertical stack is illustrated in FIG. 2 of the present application. The space between adjacent platens is generally from about 15 mm to about 25 mm. Although a stack of 17 platens, with 16 spaces between them, is illustrated in the Figures, a greater or fewer number of platens can be used depending on the size of the autoclave and height limitations that apply (e.g., for effective loading or unloading of the trays).

In the process of the present invention, hot water or a hot water/steam mixture at from about 80° C. to about 92° C. is circulated in the platens. This provides an air temperature in the autoclave of from about 45° C. to about 66° C. During this drying process, the pressure in the autoclave is decreased to about 23 inches of mercury at the start of the drying process and is then adjusted to about 30 inches of mercury during the course of the drying process. In one embodiment, the interior of the autoclave is heated to from about 45° C. to about 66° C. at 23 inches of mercury over a 10 minute period, following which the pressure in the autoclave during drying is adjusted from said 23 inches of mercury to about 30 inches of mercury over 20 minutes, with the temperature being held relatively constant. As indicated above, the space between adjacent platens is generally from about 15 mm to about 25 mm. In a preferred embodiment, the tray holding the fruit is made from metal or any other heat conductive material and it rests on the upper face of the lower platen of a pair of platens. The trays are typically made from stainless steel (although other metals which are food grade and which have durability and heat transfer properties similar to stainless steel can also be used). The trays may optionally include a non-stick coating, such as Teflon. In this embodiment, the tray itself and the fruit slices on the tray are heated by metal to metal conduction and, since the tray is also close to the platen above it, the air is heated by convection. Generally, trays are not stacked one on top of another within a single opening between adjacent platens.

The amount of time for which the drying is carried out differs from fruit-to-fruit because of the variations in moisture content and cellular structure found in the fruit, and also varies based on the thickness of the fruit slices utilized. The bottom line is that the fruit is dried until it reaches a final moisture content of from about 1% to about 7%, for example, from about 1% to about 5% at the conclusion of the drying operation. This frequently will take from about 210 minutes to about 390 minutes of drying time, although shorter or longer times can be used depending on the fruit used and the drying conditions.

One example of the fruit drying process of the present invention follows. Ripe bananas are sliced to a thickness of from about 5 to about 10 mm and are arranged on metal trays such that none of the slices touch any of the slices adjacent to it. Since additives are not used in the products of the present invention, the time for exposing the fruit to the ambient air should be minimized in order to prevent enzymatic activity from marring the surface of the fruit. In one embodiment, the time from the slicing of the fruit to the beginning of the drying process does not exceed about 40 minutes. The filled metal trays are placed in a special cart designed for holding all of the trays that will be inserted into the autoclave. The same cart is used to hold the trays of dried fruit when they are removed from the autoclave after the drying has been completed.

The autoclave is preheated by circulating hot water through the metal platens. Once the trays of raw banana slices are ready, they are inserted like drawers into the autoclave between adjacent pairs of platens. The autoclave hinge door is closed and the vacuum pump is started. The vacuum inside the autoclave should reach at least about 28 inches of mercury within about 4 minutes. Initially, the raw banana slices have a natural moisture content of the ripe fruit, about 75 to 80% for bananas and about 90% for pineapple. The start of the evaporation process is marked by a mist on the inside of the glass window at the front of the autoclave. A typical combination for drying banana slices with a 5 to 12 mm thickness is a gap between platens of about 19 mm, a vacuum in the autoclave of about 20 inches of mercury, using hot water in the platens at 90° C., and drying the banana slices to a final moisture content of about 5%. The end of the drying process is based on the drying time established by testing on each fruit (vegetable) and the initial ripeness and maturity of the fruit (vegetable) used. Once the established base drying time is achieved, the autoclave operator confirms that the thermometer inside the vapor space of the autoclave reads 50° C., and inspects the product color using the glass window in the autoclave to confirm that the product has achieved the desired color before opening the autoclave to validate the moisture level of the fruit.

When the moisture content is right, the vacuum is broken and, when the vacuum gauge indicates zero inches, the autoclave may be safely opened. The operator uses gloves and a steel hook to pull the trays out of the heat exchanger and places them in the tray cart. In one embodiment, immediately after completion of the drying (i.e., less than about 15 minutes after completion of the drying, i.e., after opening the autoclave), the dried fruit pieces are removed from the autoclave and are placed in a room having a temperature of from about 8° C. to about 20° C., and a humidity of from about 40% to about 60%, for a period of from about 0.5 to about 1 hour. The dried fruit slices are then scraped from the tray onto a belt inclined elevator and run through a bagging or packaging machine thereby forming the final product. The dried fruit slices may be packed in any conventional snack package, such as a plastic, or plastic-coated, or foil pouch, and may be packed in a nitrogen atmosphere.

The present invention also encompasses the fruit products made by the process defined above.

What is claimed is:

1. A vacuum dried fruit product made from fruit slices selected from banana, pineapple, mango, papaya, apple and pear, said product slices having a thickness of from about 2 to about 9 mm, a moisture content of from about 1% to about 7%, a porosity of no greater than about 0.45, and being substantially free of frying oil, preservatives, added sugar and artificial sweeteners.

2. The fruit product according to claim 1 wherein the fruit is selected from banana, pineapple and mango.

3. The fruit product according to claim 2 wherein the fruit is pineapple.

4. The fruit product according to claim 3 having a porosity of from about 0.3 to about 0.45.

5. The fruit product according to claim 4 having a hardness (HV 0.01) of at least about 10.0 kgf/mm².

6. The fruit product according to claim 5 having a hardness (HV 0.01) of at least about 12.0 kgf/mm².

7. The fruit product according to claim 2 wherein the fruit is mango.

8. The fruit product according to claim 7 having a porosity of from about 0.2 to about 0.3.

9. The fruit product according to claim 8 having a hardness (HV 0.01) of at least about 5.5 kgf/mm².

10. The fruit product according to claim 2 wherein the fruit is banana.

11. The fruit product according to claim 10 having a color measured using the xyz CIE scale wherein x is from about 38 to about 42, y is from about 36 to about 40, and z is from about 19 to about 23.

12. The fruit product according to claim 10 having a maximum load (F_{MAX}) of at least about 35 N.

13. The fruit product according to claim 10 having a hardness (HV 0.01) of at least about 7.0 kgf/mm² (wherein the product is aged no more than four days after making).

14. The fruit product according to claim 13 having a hardness (HV 0.01) of at least about 8.0 kgf/mm².

15. The fruit product according to claim 13 having a porosity of from about 0.35 to about 0.45.

16. The fruit product according to claim 10 having a moisture content of from about 1% to about 5%.

17. The fruit product according to claim 10 having a color measured according to the xyz CIE scale wherein x is from about 38 to about 42, y is from about 36 to about 40, and z is from about 19 to about 23; a maximum load (F_{MAX}) of at least about 35 N; a hardness (HV 0.01) of at least about 7.0 kgf/mm² (wherein the fruit product is aged for no more than four days); and a porosity of from about 0.35 to about 0.45.

18. The fruit product according to claim 17 having a moisture content of from about 1% to about 5%.

19. A vacuum dried product made from fruit or vegetable slices, said product slices having a thickness of from about 2 to about 9 mm, a moisture content of from about 1% to about 7%, a porosity of no greater than about 0.45, and being substantially free of frying oil, preservatives, added sugar and artificial sweeteners.

20. A vacuum dried product according to claim 19 made from vegetable slices.
